(19) United States
(12) Patent Application Publication
(10) Pub. No.: US 2013/0285919 A1
(43) Pub. Date: Oct. 31, 2013

(54) INTERACTIVE VIDEO SYSTEM

(71) Applicant: Eric J. LARSEN, Redwood City, CA (US)

(72) Inventor: Eric J. LARSEN, Redwood City, CA (US)

(73) Assignee: Sony Computer Entertainment Inc., Foster City, CA (US)

(21) Appl. No.: 13/455,566

(22) Filed: Apr. 25, 2012

(51) Int. Cl. G06F 3/041; G06F 3/01

(52) U.S. Cl. 345/173; 345/156

(57) ABSTRACT

An interactive video system includes a processor unit configured to provide output signals to a short throw projector. The output signals cause the short throw projector to project images on a projection area located on or parallel to a floor. The processor can receive input signals from one or more user input devices. The input signals represent a simulated user interaction with the images projected on the projection area. The processor can also alter one or more of the images projected on the projection area in response to the input signals. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### FIELD OF THE INVENTION

Embodiments of the present invention are generally directed to the field of interactive video systems and more particularly to interactive video systems that use a projector.

### BACKGROUND OF THE INVENTION

Video games are a popular form of interactive entertainment in which a user can interact with images that are presented on a screen or projected on a surface. Video game systems are sometimes in the form of a special purpose computer, sometimes referred to as a console. The console system runs game software that governs interactions that take place in a simulated environment. The console is operably connected to a video screen, such as a television set and some form of controller. The simulated environment is represented by images or graphical symbols that are presented on the video screen. A user can interact with the environment through inputs that are provided by the controller.

Advances in graphics and controllers have added to the appeal of video games. Motion controllers can track a user's movements in order to generate the inputs to the console. This can increase the realism of the interaction between the user and the simulated environment. The increased realism can enhance the user experience with the video game. One challenge to video systems is expanding the space of interaction. With a simple screen or projector, the portion of the simulated environment that the user sees is located “behind” the screen. The user cannot reach through the screen to interact with (or simulate interaction with) the game environment.

One approach to expanding the game space is to provide graphics on floor in front of the display to provide a virtual experience with virtual objects a user can interact with. This normally requires a ceiling mounted projector that projects images of the virtual objects downward onto the floor. A drawback of such a system is that because the projector is located above the user, the user often casts a shadow on the projected images.

An alternative to overhead projection is a flat panel video screen that be placed flat on the floor in front of the main display. A user can interact with the screen on the floor using the same controller that is normally used for interaction with the console. Unfortunately, a video screen placed on the floor may be damaged or destroyed if it is inadvertently stepped or kicked.

It is within this context that embodiments of the present invention arise.

### BRIEF DESCRIPTION OF THE DRAWINGS

FIGS. 1A-1B are schematic diagrams illustrating examples of an interactive video system in accordance with embodiments of the present invention.

FIG. 2 is a schematic diagram illustrating a three-dimensional short throw projector that may be used in conjunction with an embodiment of the present invention.

FIG. 3 is a block diagram illustrating an interactive video system according to an embodiment of the present invention.

### DESCRIPTION OF THE SPECIFIC EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., may be used with reference to the orientation of the figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Projectors have the benefit that they can create a large display area on a surface that is safe to stand or even jump on. The problem of where to mount the projector may be solved by “ultra-short-throw” projectors (or possibly other technology like laser “pico” projectors) that make it possible to place the projector near the television, with the projector aimed down but with a very short lateral throw.

Embodiments of the present invention may use a “short-throw” projector to display graphics on the floor in front of a television, and also use a depth camera to track the player's body over that area. These types of projectors can be placed very close to a wall, e.g., about 2-3 feet or even a few inches and project a large image on the wall. There are a number of different types of commercially available short throw projector technologies that can be easily adapted to project images on a floor or a surface more or less parallel to the floor.

The player could interact with the projected graphics, and a depth map could be used to black out areas of the projection in order to avoid projecting graphics on the player's body. The technique could also be paired with a method for precise head-tracking. One could also apply a “fish-tank virtual reality” technique to the graphics projected on the floor, creating the illusion of pits or objects above the floor. A special surface may be needed for the projection, which could have buttons or pressure sensing to facilitate interaction with the projected images.

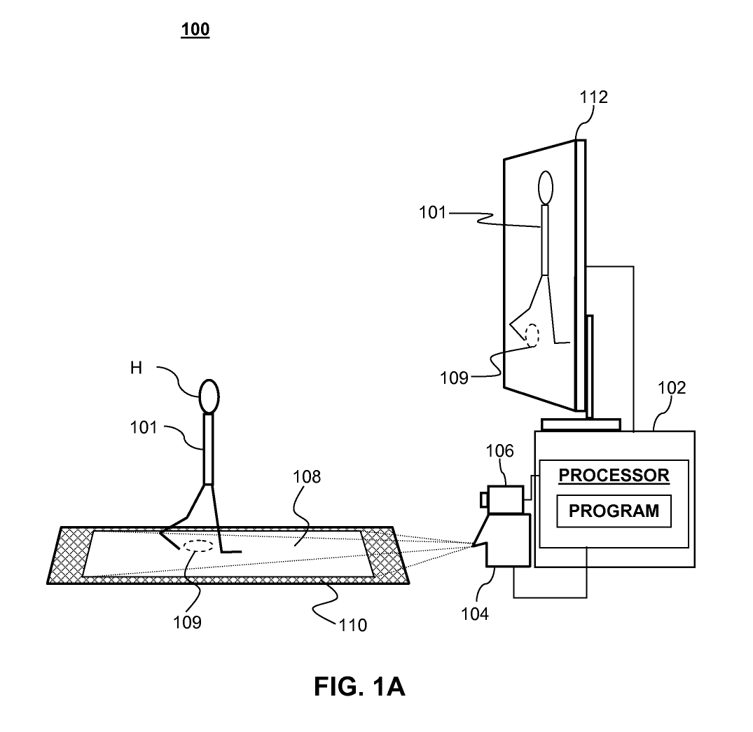

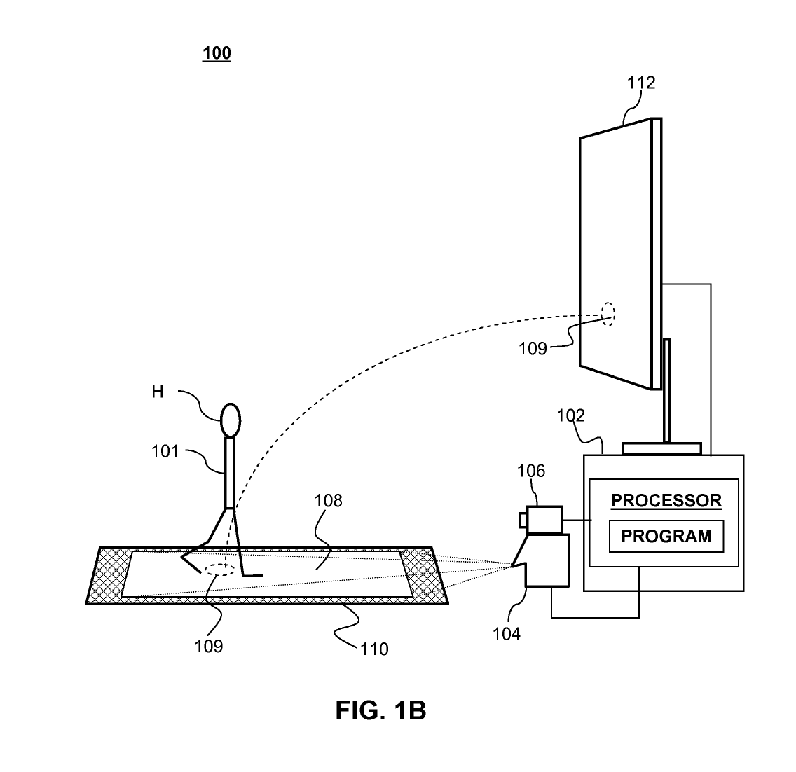

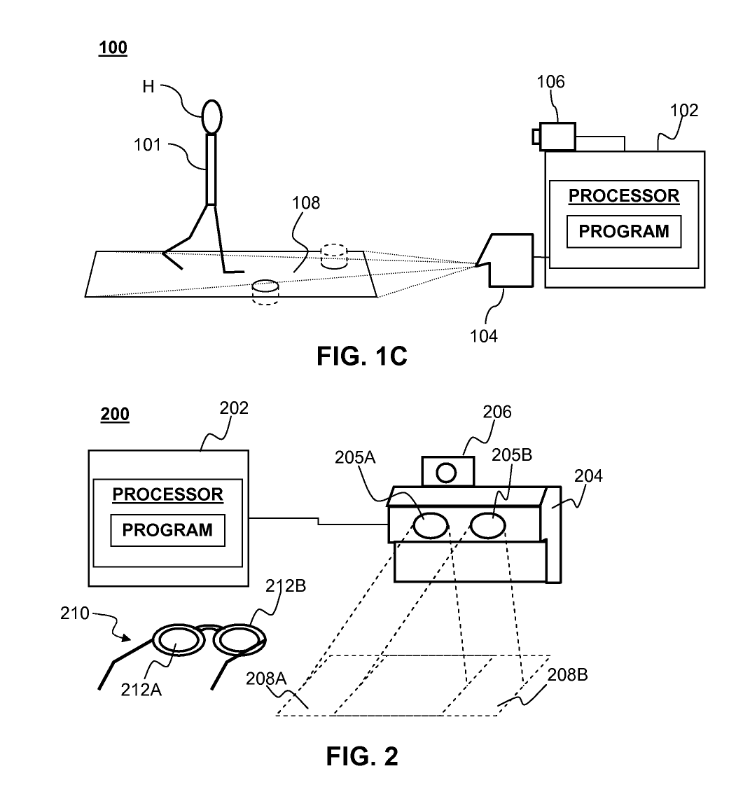

As shown in FIG. 1 and FIG. 1B, an interactive video system 100 may include a processor unit 102, and a short throw projector 104 and image capture device 106 coupled to the processor unit. The short throw projector 104 is configured to project images on a projection area 108 located on or parallel to a floor. In general, it is desirable for the short throw projector 104 to be configured to project horizontally and vertically with respect to a location of the short throw projector. This avoids the need to mount the projector 104 to the ceiling and allows for a more convenient location of the projector. This allows the projection area 108 to be located between the projector 108 and a user while still allowing images to be projected onto a projection area parallel to and close to the floor. For a projector 104 having a very short throw, e.g., a few inches, it may even be possible to place the projector on or close to floor level.

One advantage of a short throw projector is that it can be placed very close to the plane of the projection area 108, e.g., close to the floor. Such placement can greatly reduce the likelihood that the beam from the projector 104 will project into the eyes of a user 101. A similar advantage may be achieved if the projection area is on a wall or ceiling. Another advantage short throw projectors over ceiling mounted projectors is that if the projection area is on the floor there is less likelihood that the user 101 will block the projector beam and cast a shadow. Since the projector 104 can be located in front of the user rather than behind the user the user is unlikely to see any shadow due to the user's body blocking the projector beam.

Although some examples are illustrated and described in terms of projecting images on a floor or projection area parallel to a floor embodiments of the present invention are not limited to such implementations. For example, the system described above may be modified to make use of projectors that project images onto floors, walls or ceilings. Images projected by such projectors can enhance the “atmospherics” of a video game, e.g., by projecting images that fit with the theme of a game. For example, jungle vegetation could be projected on the floors, walls and ceiling for an adventure game that takes.

The processor unit 102 may be configured to provide output signals to the short throw projector 104. The output signals may be configured to cause the short throw projector to project images on the projection area 108. The processor 102 may be further configured to receive input signals from one or more user input devices. The input signals may represent a simulated interaction by a user 101 with the images projected on the projection area 108. The processor 102 may also be configured to alter one or more of the images projected on the projection area 108 in response to the input signals.

In some implementations, the processor unit 102 may be configured to analyze images of the projection area 108 that have been obtained with the image capture device 106, wherein the images obtained with the image capture device include portions of images projected by the short throw projector 104. The processor may also be configured analyze the images and determine whether a portion of a projected image is occluded by an object and to cut out projection of the portion of the projected image that is occluded. By tracking the user 101, it is possible for the processor 102 to control the projection of images by the projector 104 in a way that avoids projecting the images onto the player. For example, the processor 102 may compare a known configuration for the graphics when projected on the display area to the actual configuration of the projected graphics in images obtained by the image capture device 106. If the configuration of the projected graphics is known, the processor can determine distortions of the graphics when they are projected onto the user 101. Analysis of the distortions can be used to track the user 101 or to cut out portions of the projected images that are projected onto the user. The images projected on the projection area 108 can be thought of as a type of structured light that doubles as a visible image.

In some implementations, the system 100 may further include a touch sensor array 110 coupled to the processor unit 102. The touch sensor array 110 may include resistive or capacitive sensors or other types of sensors that respond to the contact by or proximity of a user. The sensors may be arranged in a regular pattern so that each sensor in the array has a known location relative to the array. Each sensor in the touch sensor array 110 may generate signals in response to a user's contact with or proximity. The processor unit 102 may be configured to analyze inputs from the touch sensor array in response to user interaction with the touch sensor array and to analyze images of the touch sensor array 110 obtained by the image capture device 106 and alter one or more images projected on the touch display area in response to the inputs from the touch sensor array. The processor unit 102 may optionally be configured to analyze images of the touch sensor array 110 obtained by the image capture device 106 and adjust projection of images projected by the projector 104 such that the projected images align with the touch sensor array in a predetermined manner.

In some embodiments projector screen material may be placed on the projection area 108. Under some lighting conditions, e.g., a home during the day, the projected images may exhibit poor. Some projector screen materials are engineered to mostly reflect red, green, and blue light wavelengths used by projectors, and perhaps such a surface could help improve contrast. The touch sensor array 110 may optionally be incorporated into a sheet of such projector screen material.

The user can interact with the images projected on the projection area 108 by tracking the player's hands or feet or even the user's whole body. There are a number of tracking technologies that can be used for this purpose. For example, some technologies project a “grid” of infrared light. The image capture device 106 may be (or may include) an infrared camera that can capture infrared images. In images that contain the grid and the user, the grid of infrared light may be distorted where it intersects a user relative to a reference image of the grid without the user. The distortion of the grid may be analyzed to track parts of the user's body.

Other image-based tracking techniques may use e.g., a range-finding depth sensor or stereo camera to track the user.

Still other techniques may track a controller that the user holds or that is attached to the user's hands, feet, body, or clothing. The position and/or orientation of the controller may also be tracked optically, e.g., by including a light source on the controller. The light source may be diffused by a spherically-shaped diffuser to produce of diffuse light of fixed size. Images of the diffuse light source may be captured by a digital camera that is coupled to the processor 102 and the images may be analyzed to determine the location of the light source in three dimensions. The location of the light source in the image plane can be readily determined by analyzing the images for the location of patterns characteristic of the light source. The location of the light source relative to a direction perpendicular to the image plane can be determined from the relative size of the light source, which changes as the light source moves closer to or further away from the camera.

In some techniques the controller may include one or more inertial sensors, e.g., one or more accelerometers or one or more gyroscopes, or some combination of accelerometers and gyroscopes. Signals from the inertial sensor(s) may be generated in response to changes in position and/or orientation of the controller. These signals may be analyzed to determine the position and/or orientation of the controller. In some cases, such as the Move® controller from Sony Computer Entertainment of Tokyo Japan, a diffuse spherical light source may be combined with one or more inertial sensors.

Other options for tracking the user include using microphone arrays to track the user and/or a controller.

In addition to tracking the user 101, in certain embodiments of the present invention, it may be useful to determine the position of the projector 104 relative to the location of the projection area 108 and/or the camera 106. The location of the display area can be determined if the configuration of the projected image is known. The image as seen by the camera can be compared to a reference image for known relative locations of the projection area and the camera. The differences between the image as seen by the camera and the reference image can be used to determine the relative location of the projection area 108. However, this assumes a known positional relationship between the camera and the projector.

One possible way to determine the position of the projector relative to the camera would be to maintain a fixed relationship between the camera and projector. One possible way to do this would be to incorporate the projector 104 and the camera 106 into the same device in such a way that the camera optics and projector optics are in a known positional and relationship with respect to each other. The camera optics and projector optics may be fixed relative to each other or they may be movable. In the case of moveable optics, the projector and or camera may include sensors that can detect relative position and or orientation between the projector and camera.

Alternatively, the relative position and orientation may be determined if the camera and projector are located fairly close together such that that the camera 106 can see all the areas where the projector 104 might place the projection area 108. There may be a directional difference between the camera and projector; however, this may be taken into account by a calibration step that detects the location and shape of the projection in the camera image.

In some embodiments, the user's experience may be enhanced through the use of augmented reality in conjunction with a display 112, which may be used in addition to the projector 104. The processor 102 can combine an image of the user with virtual objects to display an augmented image that includes the user and the virtual objects. For example, an object 109 in an image projected on the display area 108 and an image of the user could be combined in a synthetic image presented on the display 112, as shown in FIG. 1A. In the image on the display 112, the image of the user 101 may be obtained with the image capture device 106 and the image of the object 109 may be synthetically generated by the processor 102. The user 101 can thereby interact with virtual objects in the projected images in the display area 108 and watch the interaction on the display 112.

The use of images projected on the projection area 108 in conjunction with the display presents interesting opportunities for coordination of projected graphics and displayed graphics. For example, objects could follow trajectories from the projection area 108 to the display 112 or vice versa. By way of example, the processor 102 may analyze the user's interaction with the images in the projection area 108 and compute a trajectory of an object 109 in one or more of the projected images. The trajectory may be a three dimensional trajectory. The processor 102 can animate the object 109 so that it follows the calculated trajectory. The processor 102 can determine when and where the trajectory intersects the display unit 112.

To illustrate this concept, consider the example depicted in FIG. 1B, in which the object 109 in the image projected on the projection area is a ball. The user interacts with the object by kicking it. The processor 102 analyzes images of the projection area 108 obtained with the image capture device 106 to detect the kick and calculates a trajectory 113 for the ball 109. The user can follow the trajectory of the ball through the images projected in the projection area 108 and presented on the display 112.

In another embodiment, the projection area 108 may be treated as a window into a 3D world. An example of such an embodiment is shown in FIG. 1C. The projector 104 may be configured to project three dimensional images. The user's head H may be tracked and images may be modified accordingly to change the three-dimensional view seen by the user 101 as the user views the projection area 108 from different angles. The projector 104 could project images on the projection area containing features that have depth. Examples of such features include pits that appear to have depth below the level of the projection area 108 or projections that appear to extend above the level of the projection area.

By way of example, and not by way of limitation, the projector 104 could be configured to project 3D images using conventional stereo 3D projection technology and polarized 3D glasses. FIG. 2 Illustrates an example of how such a system would work. In this example, an interactive video system 200 includes a short throw stereo projector 204 and a camera 206 coupled to a processor 202. The stereo projector 204 includes two sets of projection optics 205A, 205B that project left eye and right eye images 208A, 208B of the same scene from vantage points that are slightly offset laterally with respect to each other. Each set of projection optics includes a polarizing filter. The polarizing filter in each set of optics imparts a different polarization to the light forming the left eye image 208A and right eye image 208B. A pair of 3D viewing glasses 210 has correspondingly polarized left and right lenses 212A, 212B. When the images 208A, 208B are viewed through the glasses the left lens 212A filters out the right eye image 208B and the right lens 212B filters out the left eye image 208A. As a result, a three dimensional image is perceived. If the user's head H is tracked, e.g., by tracking the glasses 210 with the camera 206, the processor 202 can adjust the lateral offset between the images 208A, 208B and modify the images as the user's point of view changes with respect to the location of the images.

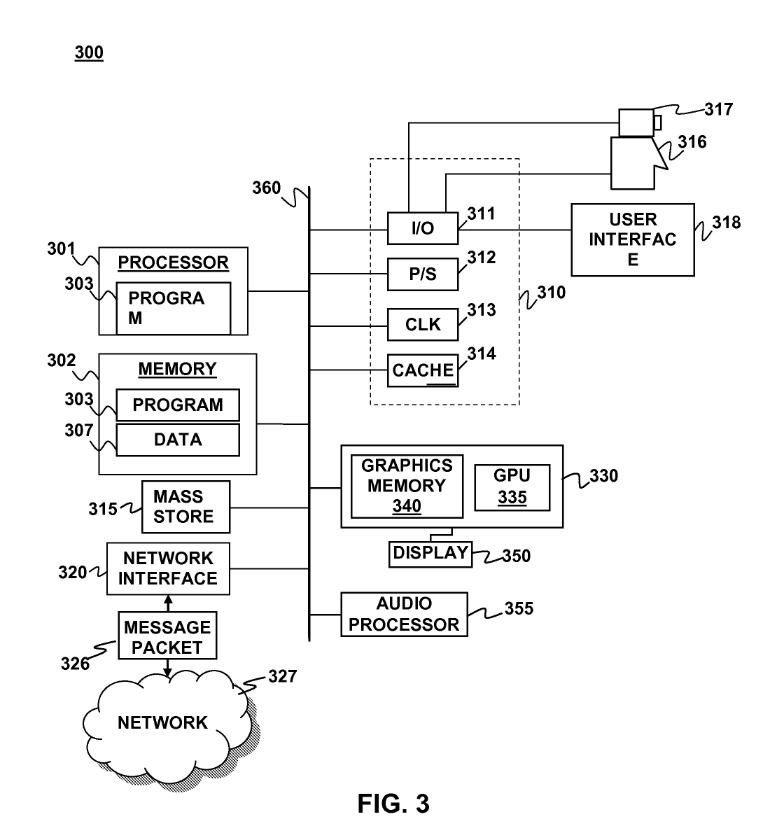

There are a number of different possible configurations for the processor and other components that are used in the systems described herein. By way of example, and not by way of limitation, FIG. 3 depicts a block diagram illustrating the components of an interactive video system 300 according to an embodiment of the present invention. By way of example, and without loss of generality, certain elements of the system 300 may be implemented with a computer system, such as a personal computer, video game console, audio player, tablet computer, cellular phone, portable gaming device, or other digital device.

The system 300 may include a processor unit 301 configured to run software applications and optionally an operating system. The processor unit 301 may include one or more processing cores. By way of example and without limitation, the processor unit 301 may be a parallel processor module that uses one or more main processors, sometimes and (optionally) one or more co-processor elements. In some implementations the co-processor units may include dedicated local storage units configured to store data and or coded instructions. Alternatively, the processor unit 301 may be any single-core or multi-core (e.g., dual core or quad core) processor.

A non-transitory storage medium, such as a memory 302 may be coupled to the processor unit 301. The memory 302 may store program instructions and data for use by the processor unit 301. The memory 302 may be in the form of an integrated circuit, e.g., RAM, DRAM, ROM, and the like). A computer program 303 and data 307 may be stored in the memory 302 in the form of instructions that can be executed on the processor unit 301. The program 303 may include instructions configured to implement, amongst other things, a method for interactive video, e.g., as described above. For example, the system 300 may be configured, e.g., through appropriate instructions in the program 303 to synchronize images projected by a projector to game activity that is displayed on a display.

The system 300 may also include well-known support functions 310, such as input/output (I/O) elements 311, power supplies (P/S) 312, a clock (CLK) 313 and cache 314. The system 300 may further include a storage device 315 that provides an additional non-transitory storage medium for processor-executable instructions and data. The storage device 315 may be used for temporary or long-term storage of information. By way of example, the storage device 315 may be a fixed disk drive, removable disk drive, flash memory device, tape drive, CD-ROM, DVD-ROM, Blu-ray, HD-DVD, UMD, or other optical storage devices. The storage device 315 may be configured to facilitate quick loading of the information into the memory 302.

One or more user interfaces 318 may be used to communicate user inputs from one or more users to the computer device 300. By way of example, one or more of the user input devices 318 may be coupled to the client device 300 via the I/O elements 311. Examples of suitable input device 320 include keyboards, mice, joysticks, game controllers, touch pads, touch screens, light pens, still or video cameras, and/or microphones. In addition, the headset 319 may be coupled to the device 300 via the I/O elements 311.

The system may include a short-throw projector 316, which may be configured as described above and a video camera 317, which may be a two-dimensional or three-dimensional camera. The projector 316 and camera 317 may be coupled to the processor via the I/O elements 311.

The client device 300 may include a network interface 325 to facilitate communication via an electronic communications network 327. The network interface 325 may be configured to implement wired or wireless communication over local area networks and wide area networks such as the Internet. The client device 300 may send and receive data and/or requests for files via one or more message packets 326 over the network 327.

In some embodiments, the device 300 may further comprise a graphics subsystem 330, which may include a graphics processing unit (GPU) 335 and graphics memory 340. The graphics memory 340 may include a display memory (e.g., a frame buffer) used for storing pixel data for each pixel of an output image. The graphics memory 340 may be integrated in the same device as the GPU 335, connected as a separate device with GPU 335, and/or implemented within the memory 306. Pixel data may be provided to the graphics memory 340 directly from the processor unit 301. Alternatively, the processor unit 301 may provide the GPU 335 with data and/or instructions defining the desired output images, from which the GPU 335 may generate the pixel data of one or more output images. The data and/or instructions defining the desired output images may be stored in memory 310 and/or graphics memory 340. In an embodiment, the GPU 335 may be configured (e.g., by suitable programming or hardware configuration) with 3D rendering capabilities for generating pixel data for output images from instructions and data defining the geometry, lighting, shading, texturing, motion, and/or camera parameters for a scene. The GPU 335 may further include one or more programmable execution units capable of executing shader programs.

The graphics subsystem 330 may periodically output pixel data for an image from the graphics memory 340 to be displayed by the projector 316 or on a separate video display device 350. The video display device 350 may be any device capable of displaying visual information in response to a signal from the client device 300, including CRT, LCD, plasma, and OLED displays. The computer client device 300 may provide the display device 350 with an analog or digital signal. By way of example, the display 350 may include a cathode ray tube (CRT) or flat panel screen that displays text, numerals, graphical symbols or images.

The components of the device 300, including the CPU 305, memory 306, support functions 310, data storage 315, user input devices 320, network interface 325, audio processor 355, and an optional geo-location device 356 may be operably connected to each other via one or more data buses 360. These components may be implemented in hardware, software or firmware or some combination of two or more of these.

While the above is a complete description of the preferred embodiments of the present invention, it is possible to use various alternatives, modifications, and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A” or “An” refers to a quantity of one or more of the item following the article, except where expressly stated otherwise. The appended claims are not to be interpreted as including means-plus-function limitations, unless such a limitation is explicitly recited in a given claim using the phrase “means for”. Any element in a claim that does not explicitly state “means for” performing a specified function, is not to be interpreted as a “means” or “step” clause as specified in 35 USC §112, ¶ 6.

What is claimed is:

1. An interactive video system, comprising:
a processor unit;
a short throw projector coupled to the processor unit, wherein the short throw projector is configured to project images on a projection area located on or parallel to a floor; and
one or more user input devices coupled to the processor, wherein the processor is further configured to receive input signals from the one or more user input devices, wherein the input signals represent a simulated user interaction with the images projected on the projection area, wherein the processor is configured to modify the images projected by the projector in response to the input signals.

2. The system of claim 1, wherein the short throw projector is configured to project horizontally and vertically with respect to a location of the short throw projector.

3. The system of claim 1, wherein the one or more user input devices include an image capture device coupled to the processor unit wherein the processor unit is configured to analyze images obtained with the image capture device and to alter one or more images projected on the projection area in response to the resulting analysis of the images.

4. The system of claim 1, wherein the one or more user input devices include an image capture unit coupled to the processor, wherein the processor unit is configured to analyze images of the display area obtained with the image capture device, wherein the images obtained with the image capture device include portions of images projected by the short throw projector, wherein the processor is configured to determine whether a portion of a projected image is occluded by an object and to cut out projection of the portion of the projected image that is occluded.

5. The system of claim 1, wherein the one or more user input devices include a touch sensor array coupled to the processor.

6. The system of claim 1, wherein the one or more user input devices include a touch sensor array and an image capture device coupled to the processor unit, wherein the processor unit is configured to analyze images of the touch sensor array obtained by the image capture device and adjust projection of images projected by the projector such that the projected images align with the touch sensor array in a predetermined manner.

7. The system of claim 1, wherein the one or more user input devices include a touch sensor array and an image capture device coupled to the processor unit, wherein the processor unit is configured to analyze images of the touch sensor array obtained by the image capture device and inputs from the touch sensor array in response to user interaction with the touch sensor array and alter one or more images projected on the touch sensor array in response to the inputs from the touch sensor array.

8. The system of claim 1, further comprising a display unit coupled to the processor, wherein the processor is configured to co-ordinate projection of images on the projection area with presentation of images on the display.

9. The system of claim 8, wherein the processor is configured to co-ordinate projection of images on the projection area with presentation of images on the display by calculating a trajectory of an object in an image projected on the projection area and projecting images on the projection area and the display that track the object from the projection area to the display.

10. The system of claim 8, wherein the processor is configured to co-ordinate projection of images on the projection area with presentation of images on the display by calculating a trajectory of an object in an image presented on the display and projecting images on the projection area and the display that track the object from the display to the projection area.

11. The system of claim 1, wherein the image capture device and the short throw projector are incorporated into the same unit such that there is a fixed relationship between relative locations of the image capture device and the short throw projector.

12. The system of claim 1, wherein the short throw projector is a stereo projection system configured to co-operate with polarized 3D glasses.

13. An interactive video system, comprising:
a processor unit,
wherein the processor unit is configured to provide output signals to a short throw projector, wherein the output signals are configured to cause the short throw projector to project images on a projection area located on or parallel to a floor;
and wherein the processor is further configured to receive input signals from one or more user input devices, wherein the input signals represent a simulated user interaction with the images projected on the projection area; and
wherein the processor is configured to alter one or more of the images projected on the projection area in response to the input signals.

14. The system of claim 13, further comprising a short throw projector coupled to the processor, wherein the short throw projector is configured to project images on a projection area located on or parallel to a floor.

15. The system of claim 14, wherein the short throw projector is configured to project horizontally and vertically with respect to a location of the short throw projector.

16. The system of claim 13, further comprising one or more input devices coupled to the processor, wherein one or more input devices are configured to generate the input signals that represent the simulated user interaction with the images projected on the projection area.

17. The system of claim 13, wherein the one or more input devices include an image capture device.

18. The system of claim 13, wherein the one or more input devices include a touch sensor array, wherein the touch sensor array includes an array of sensors, wherein each sensor in the array has a known location in the array, and wherein each sensor in the array is configured to generate an input signal in response to a user's contact with or proximity to the sensor.

19. The system of claim 13, wherein the short throw projector is configured to project three-dimensional images.

20. The system of claim 19, wherein the short throw projector is a stereo projection system configured to co-operate with polarized 3D glasses.
